(19) United States
(12) Patent Application Publication
(10) Pub. No.: US 2026/0302847 A1
(43) Pub. Date: Oct. 1, 2026

(54) MOTOR-DRIVEN COMPRESSOR

(71) Applicant: KABUSHIKI KAISHA TOYOTA JIDOSHOKKI, Kariya-shi (JP)

(72) Inventor: Shuhei SEKINAGA, Kariya-shi (JP)

(73) Assignee: KABUSHIKI KAISHA TOYOTA JIDOSHOKKI, Kariya-shi (JP)

(21) Appl. No.: 19/571,673

(22) Filed: Mar. 19, 2026

(30) Foreign Application Priority Data
Mar. 27, 2025 (JP) 2025-053734

(51) Int. Cl. H02K 1/18

(52) U.S. Cl. CPC H02K 1/185

(57) ABSTRACT

A positioning member covering an outer circumferential surface of a stator of a motor-driven compressor includes multiple protrusions protruding toward a motor fixing surface, and a first slit formed between two first end edges facing each other in a circumferential direction. An interposed member is interposed between a first housing forming portion and the positioning member and extends in the circumferential direction. The interposed member includes a second slit formed between two second end edges facing each other in the circumferential direction. A positioning recess is formed in an inner peripheral portion of the first housing forming portion by recessing, toward an end opposite to an open end, a partial region, in the circumferential direction, of the inner peripheral portion. The intervening member includes a positioning tab extending from at least one of the second end edges so as to be disposed inside the positioning recess.

### CROSS-REFERENCE TO RELATED APPLICATIONS

This application is based upon and claims the benefit of priority from Japanese Patent Application No. 2025-053734, filed on Mar. 27, 2025, the entire contents of which are incorporated herein by reference.

### BACKGROUND

### 1. Field

The present disclosure relates to a motor-driven compressor.

### 2. Description of Related Art

A motor-driven compressor includes a motor that drives a compression unit and a housing that accommodates the motor. The motor includes a rotor and a stator disposed on the outer periphery of the rotor. The stator of the motor is positioned so as not to move relative to the inner circumferential surface of the housing. For example, WO2014/129062 discloses a rotating electric machine that includes an inner case interposed between a motor case, which is a housing, and a stator. The inner case has a cylindrical shape. A stator is disposed inside the inner case. The inner case includes protrusions provided on the outer circumference. The motor case accommodates the stator and the inner case in a state in which the protrusions of the inner case are in contact with the motor case. In the rotating electric machine of the above publication, relative movement of the stator with respect to the motor case is suppressed by the contact of the protrusions with the motor case.

In the rotating electric machine disclosed in the above publication, the motor case may be damaged by the protrusions of the inner case. In order to position the stator using the protrusions, the protrusions of the inner case need to be disposed at desired positions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a motor-driven compressor includes a motor, a housing, a positioning member made of metal, and an interposed member made of metal. The motor includes a stator and is configured to drive a compression unit. The housing includes a tubular first housing forming portion that accommodates the motor, and a second housing forming portion connected to an open end of the first housing forming portion. The first housing forming portion includes a motor fixing surface that surrounds the stator. The positioning member includes a main body that extends in a circumferential direction of the motor fixing surface and covers an outer circumferential surface of the stator, and multiple protrusions protruding from the main body toward the motor fixing surface. The main body includes two first end edges facing each other in the circumferential direction, and a first slit formed between the two first edges. The interposed member includes an interposed main body interposed between the first housing forming portion and the positioning member and extending in the circumferential direction. The interposed main body includes two second end edges facing each other in the circumferential direction, and a second slit formed between the two second end edges. A positioning recess is formed in an inner peripheral portion of the first housing forming portion by recessing, in an axial direction of the first housing forming portion toward an end opposite to the open end, a partial region, in the circumferential direction, of the inner peripheral portion. The interposed member includes a positioning tab that extends from at least one of the second end edges and is disposed inside the positioning recess.

Other features and aspects will be apparent from the following detailed description, the drawings, and the claims.

### BRIEF DESCRIPTION OF THE DRAWINGS

FIG. 1 is a diagram illustrating a motor-driven compressor.

FIG. 2 is a cross-sectional view illustrating a first housing forming portion and a motor shown in FIG. 1.

FIG. 3 is a cross-sectional perspective view illustrating a positioning member and an interposed member shown in FIG. 2.

FIG. 4 is a perspective view illustrating the positioning member and a stator shown in FIG. 2.

FIG. 5 is a cross-sectional perspective view illustrating the interposed member and the first housing forming portion shown in FIG. 2.

FIG. 6 is an enlarged perspective view illustrating a positioning tab and a positioning recess shown in FIG. 5.

FIG. 7 is an enlarged view illustrating the positioning tab and the positioning recess shown in FIG. 5.

FIG. 8 is a partial cross-sectional view illustrating the positioning tab and the positioning recess shown in FIG. 5.

FIG. 9 is a diagram illustrating a state in which the stator is inserted into the first housing forming portion shown in FIG. 1.

FIG. 10 is a cross-sectional view illustrating protrusions being guided by a guide portion shown in FIG. 9.

FIG. 11 is a diagram showing relative positions of a first slit and a second slit shown in FIG. 7.

FIG. 12 is a cross-sectional perspective view illustrating a second embodiment.

FIG. 13 is an enlarged perspective view illustrating positioning tabs and a positioning recess shown in FIG. 12.

FIG. 14 is an enlarged view illustrating the positioning tabs and the positioning recess shown in FIG. 12.

FIG. 15 is a partial perspective view illustrating a positioning tab and a jig according to a modification.

FIG. 16 is a perspective view illustrating the positioning tab according to the modification shown in FIG. 15.

FIG. 17 is a diagram showing a positioning tab according to another modification.

FIG. 18 is a diagram showing positioning tabs according to still another modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

A motor-driven compressor 10 according to a first embodiment will now be described.

As shown in FIG. 1, the motor-driven compressor 10 includes a housing 11, a motor 31 accommodated in the housing 11, and a compression unit 21 accommodated in the housing 11 and driven by the motor 31.

### The Motor and the Compression Unit

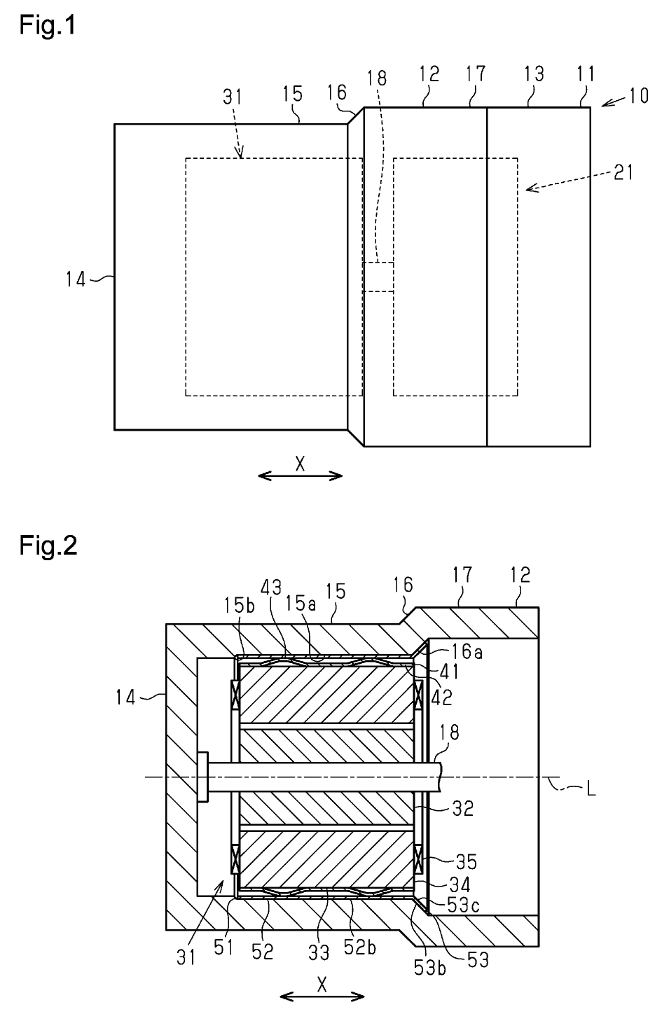

As shown in FIG. 2, the motor 31 includes a cylindrical stator 33 and a cylindrical rotor 32. The rotor 32 is located on the inner side of the stator 33. The rotor 32 rotates integrally with a rotary shaft 18. The stator 33 surrounds the rotor 32. The stator 33 includes a cylindrical stator core 34 and a motor coil 35. When electric power is supplied to the motor coil 35, the rotor 32 rotates, and the rotary shaft 18 rotates integrally with the rotor 32. The direction in which a central axis L of the rotary shaft 18 extends coincides with an axial direction X of the housing 11. The direction in which the central axis of the stator 33 extends coincides with the direction in which the central axis L of the housing 11 extends. Accordingly, the axial direction of the stator 33 is also referred to as the axial direction X.

As shown in FIG. 1, the compression unit 21 is aligned with the motor 31 in the axial direction X. The compression unit 21 is driven by rotation of the rotary shaft 18, which is driven by the motor 31. In other words, the motor 31 drives the compression unit 21. The compression unit 21 compresses refrigerant gas. The compression unit 21 may be of any type such as a scroll type or a piston type.

### Housing

The housing 11 includes a first housing forming portion 12 and a second housing forming portion 13 connected to the first housing forming portion 12. Each of the first housing forming portion 12 and the second housing forming portion 13 has a tubular shape. Each of the first housing forming portion 12 and the second housing forming portion 13 is made of metal. Each of the first housing forming portion 12 and the second housing forming portion 13 is made of, for example, aluminum. In the following description, the axial direction of the first housing forming portion 12 is referred to as the axial direction X.

The first housing forming portion 12 includes an end wall 14, a tubular motor fixing portion 15 extending from the end wall 14 in the axial direction X, a tapered portion 16 located between the motor fixing portion 15 and the second housing forming portion 13 in the axial direction X, and an enlarged portion 17 located between the tapered portion 16 and the second housing forming portion 13 in the axial direction X.

As shown in FIG. 2, the enlarged portion 17 of the first housing forming portion 12 has an opening. That is, the first housing forming portion 12 has an opening on a side opposite to the end wall 14. The second housing forming portion 13 is connected to an open end of the first housing forming portion 12 so as to cover the opening of the first housing forming portion 12.

The motor 31 is accommodated inside the motor fixing portion 15. Accordingly, the first housing forming portion 12 accommodates the motor 31. The inner circumferential surface of the motor fixing portion 15 is a motor fixing surface 15a surrounding the stator 33 of the motor 31. The housing 11 thus includes the motor fixing surface 15a. The motor fixing surface 15a is a cylindrical surface facing the outer circumference of the stator 33. The motor fixing surface 15a is provided with an annular step 15b that restricts movement of the stator 33 toward the end wall 14. However, the step 15b does not necessarily need to be provided.

The inner circumferential surface of the tapered portion 16 is a tapered surface 16a. The tapered surface 16a is inclined such that the inner diameter of the tapered portion 16 increases from the motor fixing portion 15 toward the enlarged portion 17 in the axial direction X. The tapered surface 16a is provided over the entire circumference of the tapered portion 16. Accordingly, the first housing forming portion 12 includes the tapered surface 16a defining an inner diameter that increases to a diameter greater than the inner diameter of the motor fixing surface 15a.

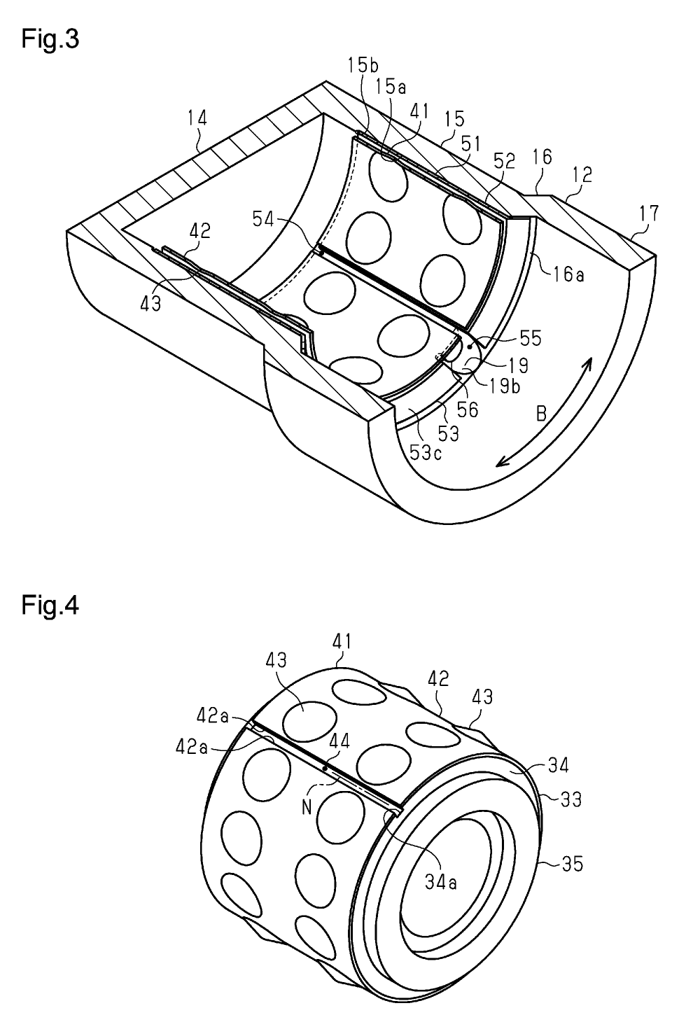

As shown in FIG. 3, the first housing forming portion 12 includes a positioning recess 19 in a partial region, in a circumferential direction B, of the inner circumferential surface. The positioning recess 19 is formed in the motor fixing surface 15a and the tapered surface 16a. The positioning recess 19 is formed so as to be recessed toward a side opposite to the open end in the axial direction X of the first housing forming portion 12. Details of the positioning recess 19 will be described later. The enlarged portion 17 is tubular and has an inner diameter greater than that of the motor fixing portion 15.

### Positioning Member

As shown in FIGS. 2 and 3, the motor-driven compressor 10 includes a positioning member 41 that positions the stator 33 with respect to the motor fixing surface 15a.

As shown in FIG. 4, the positioning member 41 is a tolerance ring. Since FIG. 4 schematically illustrates the stator 33, the stator core 34 and the motor coil 35 are illustrated in a simplified manner.

The positioning member 41 includes a main body 42 extending in a circumferential direction on the outer circumferential surface of the stator 33, and multiple protrusions 43 protruding radially outward from the outer surface of the main body 42. The main body 42 is formed by shaping a rectangular metal plate, for example, a stainless steel plate, into an arcuate shape. The main body 42 includes two first end edges 42a that are located at the opposite ends in the circumferential direction of the arcuate main body 42 and face each other. A first slit 44 is formed between the two opposing first end edges 42a of the positioning member 41. That is, the positioning member 41 is a tubular member having the first slit 44 extending in the axial direction X. A reference line N is defined as a straight line that extends through the center between the two first end edges 42a in the circumferential direction of the main body 42 and is parallel to the first end edges 42a.

Multiple protrusions 43 are provided on the main body 42 so as to be arranged in both a width direction and a circumferential direction of the main body 42. The width direction of the main body 42 coincides with the axial direction X. The protrusions 43 are arranged side by side in the width direction of the main body 42, and are arranged at equal intervals in the circumferential direction of the main body 42. When the entirety of the main body 42, including the first slit 44, is considered to form a complete annular shape, the protrusions 43 are arranged at equal intervals in the circumferential direction of the positioning member 41. Among the protrusions 43, the protrusions 43 adjacent to each first end edge 42a are disposed at a position spaced from the first end edge 42a in the circumferential direction of the main body 42.

The main body 42 of the above-described positioning member 41 is elastically deformable such that the width of the first slit 44 in the circumferential direction of the main body 42 increases and decreases. The positioning member 41 is pressed against the outer circumferential surface of the stator core 34 by elastic deformation of the main body 42. The circumferential direction of the positioning member 41 coincides with the circumferential direction of the stator 33, and the width direction of the positioning member 41 coincides with the axial direction X. Accordingly, the two first end edges 42a of the positioning member 41 face each other in the circumferential direction of the stator 33.

The stator core 34 includes a groove 34a on the outer circumferential surface. The first slit 44 of the positioning member 41 is arranged to extend along the groove 34a. The groove 34a extends straight in the axial direction X of the stator 33. The positioning member 41 is positioned at a specified position in the circumferential direction of the stator 33 by arranging the first slit 44 along the groove 34a.

### Interposed Member

As shown in FIGS. 2 and 3, the motor-driven compressor 10 includes an interposed member 51 interposed between the motor fixing portion 15 and the positioning member 41.

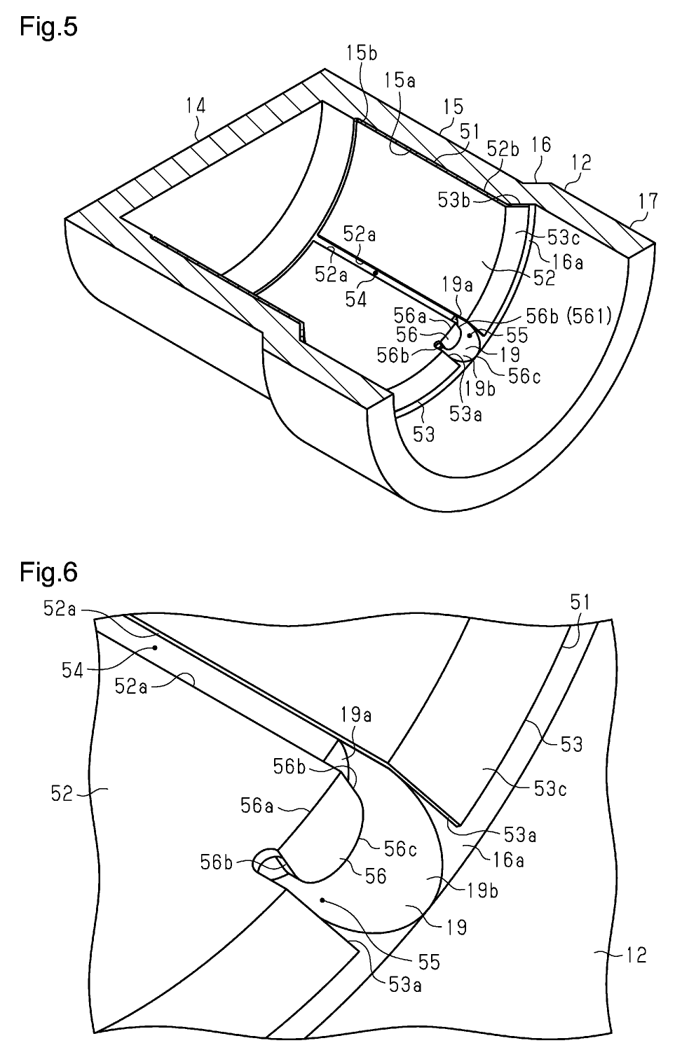

As shown in FIGS. 3 and 5, the interposed member 51 includes an interposed main body 52 extending in the circumferential direction B of the motor fixing surface 15a. The interposed member 51 is a tubular member having a second slit 54 extending in the axial direction X. The interposed member 51 includes a positioning tab 56 that extends from the interposed main body 52 and is disposed inside the positioning recess 19. The interposed member 51 is formed of, for example, a stainless steel plate.

The interposed main body 52 is formed by shaping a rectangular metal plate into an arcuate shape. The interposed main body 52 includes two second end edges 52a that are located at the opposite ends in the circumferential direction of the arcuate interposed main body 52 and face each other. A second slit 54 is formed between the two opposing second end edges 52a of the interposed member 51. The dimension of the interposed main body 52 in the width direction is slightly smaller than the dimension in the axial direction X of the first housing forming portion 12 from the boundary between the motor fixing portion 15 and the tapered portion 16 to the step 15b. The outer surface of the interposed main body 52 is a plate surface 52b. The plate surface 52b is an arcuate surface.

The interposed main body 52 includes a first arcuate end edge and a second arcuate end edge at the opposite ends in the width direction. The first arcuate end edge is in contact with the step 15b. The interposed member 51 includes a guide portion 53. The guide portion 53 protrudes in the axial direction X from the second arcuate end edge of the interposed main body 52. The guide portion 53 has a shape similar to a circumferential surface of a truncated cone, in which a diameter gradually increases in the axial direction X as the guide portion 53 extends away from the interposed main body 52.

The outer surface of the guide portion 53 is a contact surface 53b that contacts the tapered surface 16a. The inner surface of the guide portion 53 is a guide surface 53c.

As shown in FIG. 6, the guide portion 53 includes two guide portion end edges 53a located at the opposite ends in the circumferential direction of the guide portion 53, which extends arcuately. A third slit 55 is formed between the two opposing guide portion end edges 53a. In the circumferential direction of the interposed main body 52, the opening width of the third slit 55 is greater than the opening width of the second slit 54.

The interposed main body 52 of the interposed member 51 described above is elastically deformable such that the width of the second slit 54 in the circumferential direction of the interposed main body 52 increases and decreases. The interposed member 51 is pressed against the motor fixing surface 15a by elastic deformation of the interposed main body 52. The circumferential direction of the interposed main body 52 coincides with the circumferential direction B of the motor fixing surface 15a, and the width direction of the interposed main body 52 coincides with the axial direction X. In the interposed member 51, the two second end edges 52a are opposed to each other in the circumferential direction B of the motor fixing surface 15a.

### Positioning Tab

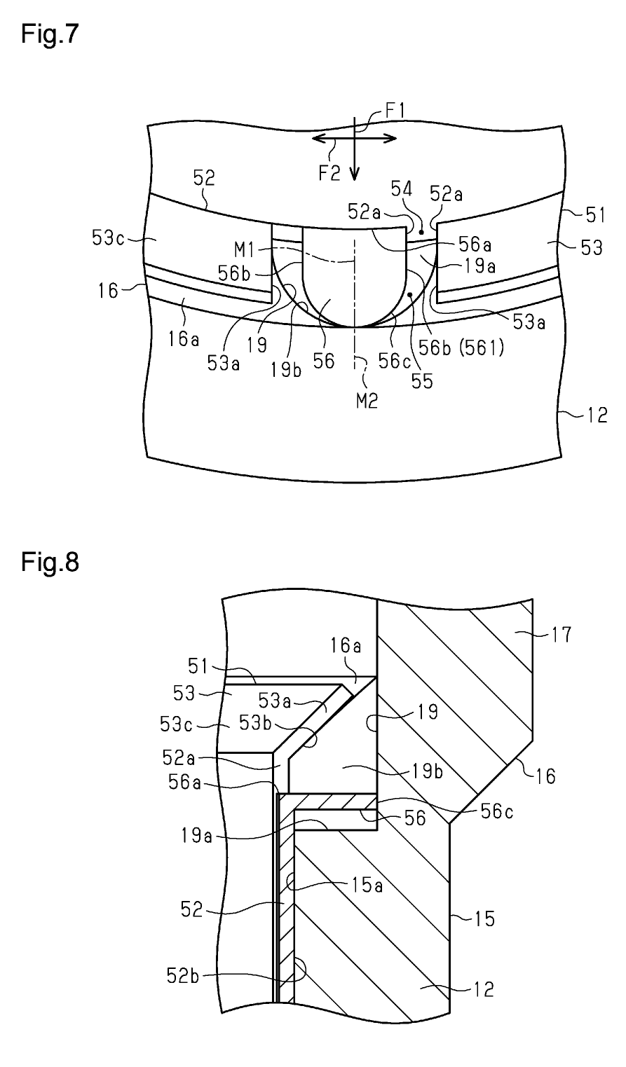

As shown in FIGS. 6 and 7, the interposed member 51 includes a positioning tab 56 extending outward in the radial direction of the interposed main body 52 from one of the second end edges 52a of the interposed main body 52. The positioning tab 56 is provided on the same side as the second arcuate end edge, from which the guide portion 53 protrudes, between the first and second arcuate end edges of the interposed main body 52. The positioning tab 56 is formed at a position closer to the center in the width direction of the interposed main body 52 than the guide portion 53 is. The positioning tab 56 is formed by bending the metallic plate forming the interposed main body 52 toward the plate surface 52b. A proximal end 56a of the positioning tab 56 is located at the bent portion of the interposed main body 52.

The positioning tab 56 includes two side edges 56b extending from the opposite ends of the proximal end 56a, and a distal end edge 56c connecting the two side edges 56b. The two side edges 56b and the distal end edge 56c are edges that form the outer shape of the positioning tab 56 when the positioning tab 56 is viewed in the axial direction X. Accordingly, the positioning tab 56 includes the proximal end 56a located at the boundary with the interposed main body 52, the distal end edge 56c located at the opposite side from the proximal end 56a in the extending direction of the positioning tab 56, and the two side edges 56b connecting the proximal end 56a and the distal end edge 56c to each other. The two side edges 56b are straight and extend parallel to each other. The distal end edge 56c is arcuate. In the positioning tab 56, a direction from the proximal end 56a located at the boundary with the interposed main body 52 toward the distal end of the positioning tab 56 is defined as an extending direction F1. The extending direction F1 is parallel to the thickness direction of the second end edges 52a of the interposed member 51.

A direction in which a straight line along the front surface of the positioning tab 56 and orthogonal to the extending direction F1 extends is a width direction F2 of the positioning tab 56. The dimension in the width direction F2 of the positioning tab 56 between the two side edges 56b is constant. Accordingly, the dimension in the width direction F2 between the two side edges 56b is equal to the dimension in the width direction F2 of the proximal end 56a. The dimension in the width direction F2 of the positioning tab 56 gradually decreases from the boundary between the side edges 56b and the distal end edge 56c toward the distal end of the distal end edge 56c, that is, the distal end of the positioning tab 56. The distal end refers to the most distal section of the distal end edge 56c, which is a location most distant from the proximal end 56a in the extending direction F1.

As shown in FIG. 6, one of the two side edges 56b of the positioning tab 56 is continuous with one of the second end edges 52a that forms the positioning tab 56. This one of the side edges 56b is a continuous end edge 561 continuous with one of the two second end edges 52a, which form the second slit 54. The continuous end edge 561 does not extend in the circumferential direction of the interposed main body 52.

The positioning tab 56 is formed such that one of the two side edges 56b serves as the continuous end edge 561. Accordingly, the other side edge 56b of the positioning tab 56 is separated from the second end edges 52a of the interposed main body 52 in the circumferential direction of the interposed main body 52. Therefore, the positioning tab 56 is formed continuously with the second slit 54 in the circumferential direction of the interposed main body 52, and extends in a direction away from the second slit 54.

### Positioning Recess

The positioning recess 19, which is formed in the first housing forming portion 12, will now be described.

As shown in FIGS. 6, 7, and 8, the positioning recess 19 is formed in an inner peripheral portion of the first housing forming portion 12 by recessing, in the axial direction X toward the end opposite to the open end of the first housing forming portion 12, a partial region, in the circumferential direction B, of the motor fixing portion 15. Specifically, the positioning recess 19 is formed by recessing parts of the tapered surface 16a and the motor fixing surface 15a. When viewed in the axial direction X, the positioning recess 19 includes an inner surface 19b, which is recessed with respect to both the tapered surface 16a and the motor fixing surface 15a so as to be open on the motor fixing surface 15a. When viewed in the axial direction X, the inner surface 19b is an arcuate surface that is recessed toward the radially outer side of the first housing forming portion 12 with respect to the motor fixing surface 15a and the tapered surface 16a. The positioning recess 19 includes an inner bottom surface 19a having a semicircular shape when viewed in the axial direction X. Accordingly, the positioning recess 19 has a depth in the axial direction X and opens to the inner circumferential surface of the first housing forming portion 12.

Positioning Member and Interposed Member in Motor-Driven Compressor

As shown in FIGS. 2 and 3, the main body 42 of the positioning member 41 extends in the circumferential direction B of the motor fixing surface 15a and covers the outer circumferential surface of the stator 33 in the motor-driven compressor 10. The first slit 44 of the positioning member 41 is formed between the two first end edges 42a of the main body 42, which face each other in the circumferential direction B of the motor fixing surface 15a. The protrusions 43 of the positioning member 41 protrude from the main body 42 toward the motor fixing surface 15a.

The interposed main body 52 of the interposed member 51 extends in the circumferential direction B of the motor fixing surface 15a in the motor-driven compressor 10. The second slit 54 of the interposed member 51 is formed between the two second end edges 52a of the interposed main body 52, which face each other in the circumferential direction B of the motor fixing surface 15a. The interposed member 51 is interposed between the first housing forming portion 12 and the positioning member 41.

The interposed main body 52 is interposed between the motor fixing portion 15 and the main body 42. The protrusions 43 of the positioning member 41 press the interposed main body 52 from the inside toward the motor fixing portion 15. Accordingly, movement of the stator 33 in the circumferential direction B is restricted by the positioning member 41. Each of the protrusions 43 is pressed against the inner circumferential surface of the interposed main body 52, and therefore does not contact the motor fixing surface 15a.

As shown in FIGS. 6 and 8, the interposed member 51 is pressed against the motor fixing portion 15 in a state in which the plate surface 52b of the interposed main body 52 faces the motor fixing surface 15a and the contact surface 53b of the guide portion 53 is in contact with the tapered surface 16a of the tapered portion 16. Accordingly, most of the tapered surface 16a and the motor fixing surface 15a, which are parts of the inner circumferential surface of the first housing forming portion 12, are covered by the interposed member 51.

The positioning tab 56 is disposed inside the positioning recess 19. The positioning tab 56 is arranged inside the positioning recess 19 in a state in which each of the two side edges 56b and the distal end edge 56c faces the inner surface 19b of the positioning recess 19.

As shown by a long-dash short-dash line in FIG. 7, a straight line that extends through the center of the positioning tab 56 in the circumferential direction B of the motor fixing surface 15a and extends in the extending direction F1 when viewed in the axial direction X is a first imaginary line M1. A straight line that extends through the center of the positioning recess 19 in the circumferential direction B of the motor fixing surface 15a and extends in the extending direction F1 when viewed in the axial direction X is a second imaginary line M2. The positioning tab 56 is disposed inside the positioning recess 19 in a state in which the first imaginary line M1 coincides with the second imaginary line M2 of the positioning recess 19. The positioning member 41 and the interposed member 51 are disposed such that the reference line N of the first slit 44 coincides with the second imaginary line M2 of the positioning recess 19 in the circumferential direction B of the motor fixing surface 15a and in the circumferential direction of the stator 33.

The two side edges 56b face the arcuate inner surface 19b. The two side edges 56b progressively become closer to the arcuate inner surface 19b toward the distal end of the positioning tab 56 in the extending direction F1. Accordingly, when a force acts on the interposed member 51 to move the interposed member 51 in the circumferential direction B of the motor fixing surface 15a, one of the two side edges 56b is brought into prompt contact with the inner surface 19b.

### Method of Inserting Stator

A method of inserting the stator 33 into the first housing forming portion 12 will be described.

As shown in FIG. 4, an operator presses the positioning member 41 against the outer circumferential surface of the stator 33 while aligning the first slit 44 of the positioning member 41 with the groove 34a of the stator core 34. The operator press-fits the interposed member 51 into the motor fixing portion 15 from the opening of the first housing forming portion 12.

At this time, as shown in FIG. 7, the operator aligns the first imaginary line M1 of the positioning tab 56 with the second imaginary line M2 of the positioning recess 19. Inside the positioning recess 19, the positioning tab 56 is opposed to the inner bottom surface 19a of the positioning recess 19 in the axial direction X, and the two side edges 56b of the positioning tab 56 are opposed to the inner surface 19b of the positioning recess 19. Accordingly, even if a force to move the interposed member 51 in the circumferential direction B of the motor fixing surface 15a acts on the interposed member 51, the side edge 56b and the distal end edge 56c located at the leading end of the direction of the force to move the interposed member 51 immediately come into contact with the inner surface 19b. Thus, the movement of the interposed member 51 is restricted. Therefore, when the positioning tab 56 is disposed inside the positioning recess 19, the relative position of the interposed member 51 with respect to the motor fixing surface 15a is fixed. That is, the interposed member 51 is disposed at a specified position in the circumferential direction B of the motor fixing surface 15a by disposing the positioning tab 56 inside the positioning recess 19. The positioning tab 56 extends from the second end edge 52a of the interposed main body 52, which forms the second slit 54. Therefore, when the positioning tab 56 is disposed inside the positioning recess 19, the second slit 54 is disposed at a position adjacent to the positioning recess 19.

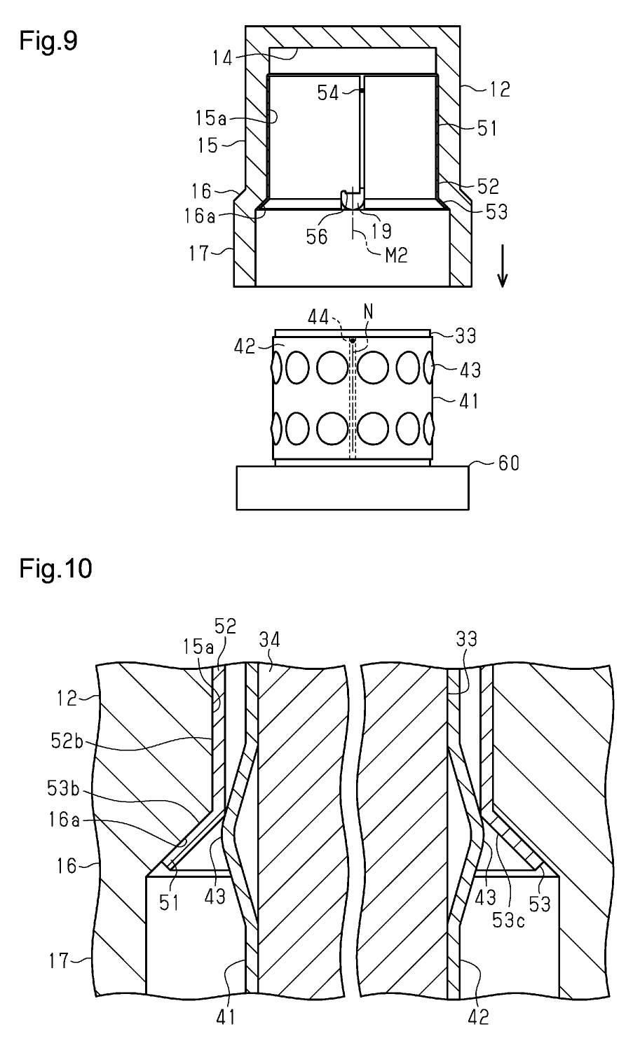

As shown in FIG. 9, the operator places the stator 33, against which the positioning member 41 is pressed, on a mounting table 60. At this time, the stator 33 is mounted on the mounting table 60 in a state in which rotation of the stator 33 in the circumferential direction is restricted.

Next, the operator sets the first housing forming portion 12, into which the interposed member 51 has been press-fitted, in a jig (not shown). The jig and the mounting table 60 are set such that the positioning recess 19 of the first housing forming portion 12 and the first slit 44 of the positioning member 41 coincide with each other in the circumferential direction B of the motor fixing surface 15a and in the circumferential direction of the stator 33, that is, the positioning recess 19 and the first slit 44 overlap each other when viewed in the radial direction of the housing 11. Specifically, the positions of the jig and the mounting table 60 are set such that the reference line N of the first slit 44 coincides with the second imaginary line M2 of the positioning recess 19 in the circumferential direction B of the motor fixing surface 15a and in the circumferential direction of the stator 33.

The positioning tab 56 of the interposed member 51 is arranged inside the positioning recess 19 of the first housing forming portion 12 set in the jig. Accordingly, the interposed member 51 is disposed at a specified position in the circumferential direction B of the motor fixing surface 15a.

Next, the operator lowers the jig (not shown) toward the mounting table 60. Then, the positioning member 41 and the stator 33 are press-fitted into the motor fixing portion 15 through the enlarged portion 17 and the tapered portion 16 of the first housing forming portion 12. At this time, as shown in FIG. 10, the protrusions 43 of the positioning member 41 are guided by the guide surface 53c of the guide portion 53 when being press-fitted into the motor fixing portion 15 from the tapered portion 16.

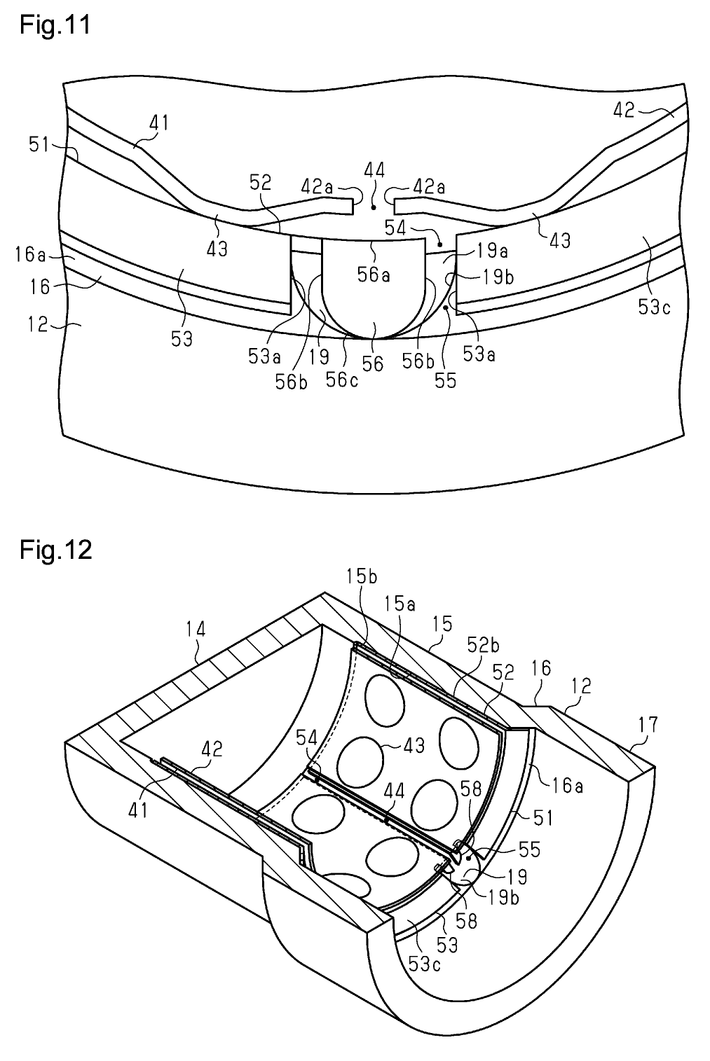

As shown in FIG. 11, when the stator 33 is press-fitted into the motor fixing portion 15, the stator 33 is positioned in the motor fixing portion 15 by the positioning member 41. In the circumferential direction B of the motor fixing surface 15a and in the circumferential direction of the stator 33, the position of the positioning recess 19 of the first housing forming portion 12 and the position of the first slit 44 of the positioning member 41 are aligned at the same position. Accordingly, in the circumferential direction B of the motor fixing surface 15a and in the circumferential direction of the stator 33, the first slit 44 and the second slit 54 are arranged such that the relative positional relationship therebetween is a specified relative positional relationship. Thus, the protrusions 43 of the positioning member 41 are prevented from entering the second slit 54 of the interposed member 51. In other words, the protrusions 43 are disposed at positions separated from the second slit 54 in the circumferential direction B of the motor fixing surface 15a.

### Advantages of the First Embodiment

(1-1) The positioning tab 56 is disposed at a specified position in the circumferential direction B of the motor fixing surface 15a by disposing the positioning tab 56 inside the positioning recess 19. When the positioning tab 56 is disposed inside the positioning recess 19, the relative position of the second slit 54 with respect to the positioning recess 19 is determined, and the second slit 54 is prevented from being disposed at a random position in the circumferential direction B of the motor fixing surface 15a. Accordingly, when the stator 33 is inserted together with the positioning member 41 from the opening of the first housing forming portion 12, the positioning member 41 is positioned such that the relative positional relationship between the first slit 44 and the second slit 54 is a desired relative positional relationship in the motor-driven compressor 10 by adjusting the relative position of the first slit 44 of the positioning member 41 with respect to the positioning recess 19 of the first housing forming portion 12. As a result, the protrusions 43 of the positioning member 41 are prevented from entering the second slit 54 of the interposed member 51. Accordingly, it is possible to suppress a decrease in the pressing force by the protrusions 43 due to some of the protrusions 43 overlapping the second slit 54.

Since the interposed main body 52 of the interposed member 51 is interposed between the motor fixing surface 15a and the positioning member 41, the interposed main body 52 protects the motor fixing surface 15a from the protrusions 43. As a result, the motor fixing surface 15a is prevented from being damaged by the protrusions 43. As described above, the motor-driven compressor 10 prevents the housing 11 from being damaged by the positioning member 41 and the interposed member 51, and allows the protrusions 43 of the positioning member 41 to be arranged at desired positions.

(1-2) The positioning tab 56 is formed at a position closer to the center in the width direction of the interposed main body 52 than the guide portion 53 is. Accordingly, when the positioning tab 56 is not disposed inside the positioning recess 19, the positioning tab 56 interferes with the motor fixing surface 15a or the tapered surface 16a, and thus the interposed member 51 cannot be pressed against the first housing forming portion 12. Therefore, since the interposed member 51 includes the positioning tab 56, the interposed member 51 can be pressed against the first housing forming portion 12 in a state in which a relative position with respect to the motor fixing surface 15a is a specified relative position.

(1-3) In the positioning tab 56, the dimension in the width direction F2 between the two side edges 56b is equal to the dimension in the width direction F2 of the proximal end 56a. For example, the positioning tab 56 is more likely to come into contact with the inner surface 19b of the positioning recess 19 than in a case in which the dimension between the two side edges 56b in the width direction F2 decreases from the proximal end 56a toward the distal end edge 56c in the extending direction F1. As a result, since movement of the interposed member 51 in the circumferential direction B of the motor fixing surface 15a is restricted more reliably, it is possible to more accurately determine the position of the interposed member 51 such that the relative positional relationship between the first slit 44 and the second slit 54 is a desired relative positional relationship.

(1-4) The extending direction F1 of the positioning tab 56 from the interposed main body 52 is parallel to the thickness direction of the second end edge 52a. Therefore, when the interposed member 51 is formed by processing a metal plate, the positioning tab 56 is easily formed.

(1-5) Only one positioning tab 56 is provided on the interposed main body 52. For example, the interposed member 51 is more readily manufactured than in a case in which two positioning tabs 56 are provided on the interposed main body 52. When the interposed member 51 is positioned by bringing the two positioning tabs 56 into contact with the inner surface 19b of the positioning recess 19, the positions of the positioning recess 19 and the positioning tabs 56 in the circumferential direction B of the motor fixing surface 15a are likely to change due to the influence of the dimensional tolerance of the motor fixing surface 15a and the dimensional tolerance of the interposed member 51. However, in a configuration in which only one positioning tab 56 is provided on the interposed main body 52, it is possible to suppress the influence of the variation in the positions of the positioning recess 19 and the positioning tab 56 in the circumferential direction B of the motor fixing surface 15a due to the above-described dimensional tolerances.

(1-6) When the stator 33 is inserted into the first housing forming portion 12 together with the positioning member 41, the positioning member 41 is positioned such that the reference line N of the first slit 44 coincides with the second imaginary line M2 of the positioning recess 19 in the circumferential direction B of the motor fixing surface 15a and in the circumferential direction of the stator 33. Therefore, the center of the first slit 44 is aligned with the center of the positioning recess 19 in the circumferential direction B of the motor fixing surface 15a. This prevents the protrusions 43 from being positioned in the second slit 54.

(1-7) In the motor-driven compressor 10, in which the stator 33 is positioned in the first housing forming portion 12 by using the positioning member 41, the interposed member 51 is required to protect the motor fixing surface 15a from the protrusions 43 of the positioning member 41. The motor-driven compressor 10 is configured such that the protrusions 43 do not enter the second slit 54 of the interposed member 51 with a simple configuration in which the positioning tab 56 is formed on the interposed member 51 and the positioning recess 19 is formed in the first housing forming portion 12. In other words, the motor-driven compressor 10 uses the existing interposed member 51 for protecting the motor fixing surface 15a to prevent the protrusions 43 from entering the second slit 54. Accordingly, unlike a case in which a new member is added, the stator 33 is positioned by the positioning member 41 while suppressing an increase in manufacturing cost.

(1-8) The positioning recess 19 is formed on the inner circumferential surface of the first housing forming portion 12 and is recessed in a direction away from the open end of the first housing forming portion 12. The positioning tab 56 is disposed inside the positioning recess 19. Accordingly, after the stator 33 is positioned in the first housing forming portion 12, the positioning recess 19 and the second slit 54 can be visually verified. It is thus also possible to visually verify whether any of the protrusions 43 overlap the second slit 54.

### Second Embodiment

A motor-driven compressor 10 according to a second embodiment will now be described. The second embodiment is different from the first embodiment in the structure of positioning tabs. Thus, like or the same reference numerals are given to those components that are like or the same as the corresponding components of the first embodiment.

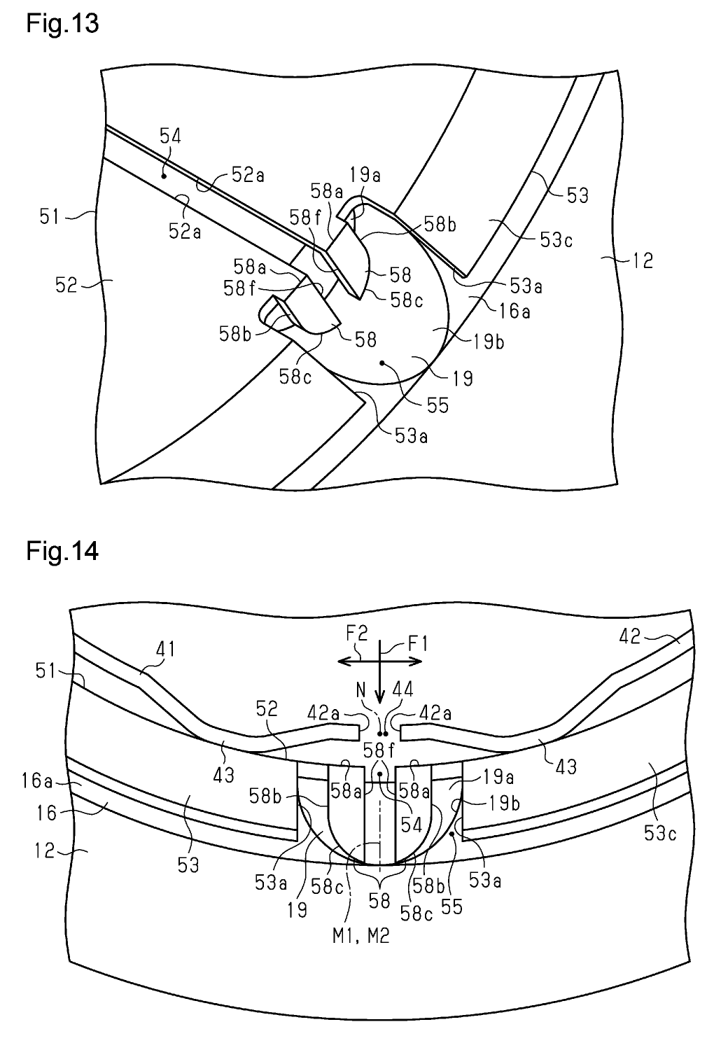

As shown in FIGS. 12, 13, and 14, two positioning tabs 58 of the interposed member 51 respectively extend from the two second end edges 52a. That is, the two positioning tabs 58 are formed on the opposite sides of the second slit 54 in the circumferential direction of the interposed member 51. The two positioning tabs 58 each include a slit forming edge 58f and a side edge 58b. The slit forming edges 58f form a part of the second slit 54 while facing each other. Each side edge 58b faces the inner surface 19b on the opposite side of the corresponding slit forming edge 58f in the circumferential direction of the interposed member 51. Each of the positioning tabs 58 is provided with an arcuate distal end edge 58c connecting the slit forming edge 58f and the side edge 58b.

In each positioning tab 58, the slit forming edge 58f, the side edge 58b, and the distal end edge 58c are edges that form the outer shape of the positioning tab 58 when the positioning tab 58 is viewed in the axial direction X. The slit forming edge 58f and the side edge 58b are linear and extend parallel to each other. In each positioning tab 58, a direction from the proximal end 58a toward the distal end is defined as an extending direction F1 from the interposed main body 52. Since each positioning tab 58 extends so as to protrude from the interposed main body 52 perpendicularly to the axial direction X, the extending direction F1 is parallel to the thickness direction of the second end edge 52a.

A direction in which a straight line along the front surface of the positioning tabs 58 and orthogonal to the extending direction F1 extends is a width direction F2 of the positioning tabs 58. The dimension between the side edge 58b and the slit forming edge 58f in the width direction F2 is constant from the proximal end of each positioning tab 58 to the distal end edge 58c. The dimension of each positioning tab 58 in the width direction F2 gradually decreases from the boundary between the side edge 58b and the distal end edge 58c toward the distal end of the positioning tab 58.

A straight line extending through the center between the two slit forming edges 58f is defined as a first imaginary line M1. The interposed member 51 is disposed such that the first imaginary line M1 coincides with the second imaginary line M2 of the positioning recess 19. Accordingly, when viewed in the axial direction X, the two positioning tabs 58 and the second slit 54 are arranged in the positioning recess 19 while being adjacent to the positioning recess 19. The two positioning tabs 58 are arranged such that the first imaginary line M1 coincides with the reference line N of the first slit 44 of the positioning member 41 in the circumferential direction B of the motor fixing surface 15a and in the circumferential direction of the stator 33. Accordingly, the positioning member 41 and the interposed member 51 are disposed in a state in which the first slit 44 and the second slit 54 overlap each other. In other words, the positioning member 41 and the interposed member 51 are disposed such that the circumferential positions of the first slit 44 and the second slit 54 coincide with each other.

In the second embodiment, when inserting the stator 33 into the first housing forming portion 12, the operator aligns the first imaginary line M1 of the positioning tabs 58 with the second imaginary line M2 of the positioning recess 19. Inside the positioning recess 19, the positioning tabs 58 are opposed to the inner bottom surface 19a of the positioning recess 19 in the axial direction X, and the side edges 58b are opposed to the inner surface 19b of the positioning recess 19. Accordingly, the relative position of the interposed member 51 with respect to the motor fixing surface 15a is fixed. The second slit 54 is disposed at the center of the positioning recess 19.

Next, the operator sets the first housing forming portion 12, into which the interposed member 51 has been press-fitted, in a jig (not shown). In this case also, the jig and the mounting table 60 are set such that the positioning recess 19 of the first housing forming portion 12 and the first slit 44 of the positioning member 41 coincide with each other in the circumferential direction B of the motor fixing surface 15a and in the circumferential direction of the stator 33. The positioning tabs 58 of the interposed member 51 are arranged inside the positioning recess 19 of the first housing forming portion 12 set in the jig. Accordingly, the interposed member 51 is disposed at a specified position in the circumferential direction B of the motor fixing surface 15a.

When the stator 33 is press-fitted into the motor fixing portion 15, the stator 33 is positioned in the motor fixing portion 15 by the positioning member 41. The positioning member 41 is positioned such that the position of the positioning recess 19 of the first housing forming portion 12 and the position of the first slit 44 of the positioning member 41 are aligned in the circumferential direction B of the motor fixing surface 15a and in the circumferential direction of the stator 33. Accordingly, the first slit 44 and the second slit 54 are arranged such that a relative positional relationship therebetween is a specified relative positional relationship. Thus, the protrusions 43 of the positioning member 41 are prevented from entering the second slit 54 of the interposed member 51. In other words, the protrusions 43 are disposed at positions separated from the second slit 54 in the circumferential direction B of the motor fixing surface 15a.

### Advantages of the Second Embodiment

In addition to the advantages (1-1) to (1-4), (1-7), and (1-8) of the first embodiment, the second embodiment achieves the following advantage.

(2-1) The interposed member 51 includes the two positioning tabs 58 provided with the second slit 54 interposed therebetween. When the interposed member 51 and the positioning member 41 are aligned such that the first imaginary line M1 located between the two positioning tabs 58 coincides with the reference line N of the positioning member 41 in the circumferential direction B of the motor fixing surface 15a and in the circumferential direction of the stator 33, the second slit 54 of the interposed member 51 and the first slit 44 of the positioning member 41 coincide with each other in the circumferential direction B of the motor fixing surface 15a and in the circumferential direction of the stator 33. This prevents the protrusions 43 from overlapping the second slit 54 of the interposed member 51.

### Modifications

Each of the above-described embodiments may be modified as follows. The above embodiments and the modifications described below may be combined as long as there is no technical contradiction.

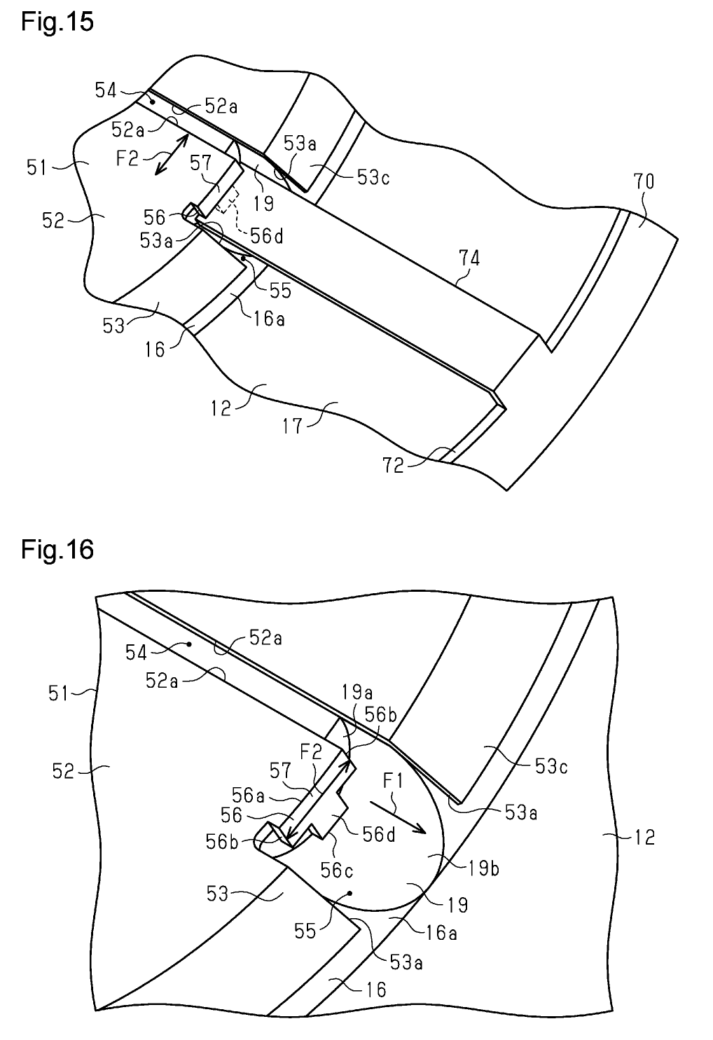

As shown in FIG. 15, movement of the interposed member 51 in the circumferential direction B of the motor fixing surface 15a may be suppressed by positioning the positioning tab 56 using a jig 70 while the positioning tab 56 is disposed inside the positioning recess 19.

As shown in FIG. 16, the positioning tab 56 includes a proximal end region 57 including the proximal end 56a located at the boundary with the interposed main body 52, and a protruding section 56d protruding from the center of the proximal end region 57 in the extending direction F1. When viewed in the axial direction X, the dimension in the width direction F2 of the protruding section 56d is smaller than the dimension in the width direction F2 of the proximal end region 57. The protruding section 56d protrudes from a position closer to the center than the opposite ends of the proximal end region 57 are in the circumferential direction B of the motor fixing surface 15a. In other words, the protruding section 56d projects from a central portion between the two side edges 56b in the proximal end region 57. The protruding section 56d has an elongated rectangular shape. Since the positioning tab 56 is formed with the protruding section 56d, the dimension in the width direction F2 at the proximal end 56a is greater than the dimension in the width direction F2 at the distal end.

As shown in FIG. 15, the jig 70 is mounted on the enlarged portion 17 of the first housing forming portion 12. The jig 70 includes a ring member 72 and a projecting portion 74 extending from an inner peripheral edge of the ring member 72.

The projecting portion 74 extends in an elongated plate shape from a part of the ring member 72 in the circumferential direction. A distal end portion of the projecting portion 74 is bifurcated. The distal ends of the projecting portion 74 sandwich the protruding section 56d from the opposite sides in the width direction F2 to position the protruding section 56d.

When the interposed member 51 is positioned by using the protruding section 56d disposed inside the positioning recess 19 and the jig 70, first, the interposed member 51 is press-fitted into the motor fixing portion 15. Next, the jig 70 is mounted on the first housing forming portion 12, and the distal end portions of the projecting portion 74 are inserted into the positioning recess 19. The jig 70 therefore includes the projecting portion 74, which is inserted into the first housing forming portion 12 from the opening of the first housing forming portion 12. Then, the bifurcated distal ends of the projecting portion 74 sandwich the protruding section 56d from the opposite sides in the width direction F2. At this time, the mounting position of the jig 70 is adjusted such that the first imaginary line M1 of the positioning tab 56 and the second imaginary line M2 of the positioning recess 19 coincide with each other. As a result, the position of the interposed member 51 relative to the first housing forming portion 12 is determined, and movement of the interposed member 51 in the circumferential direction B of the motor fixing surface 15a is suppressed. Then, in a state in which the interposed member 51 is positioned by the jig 70, the stator 33 is press-fitted into the first housing forming portion 12.

According to this modification, the interposed member 51 is prevented from moving in the circumferential direction B of the motor fixing surface 15a by the jig 70. Thus, the interposed member 51 is positioned using the jig 70, and the positioning tab 56, by including the protruding section 56d, has a shape that facilitates positioning by the jig 70.

In the first embodiment, the dimension between the two side edges 56b in the width direction F2 is the same as the dimension of the proximal end 56a in the width direction F2 from the proximal end 56a to the distal end edge 56c. However, the dimension between the two side edges 56b in the width direction F2 may be greater than the dimension of the proximal end 56a in the width direction F2. For example, the positioning tab 56 may be formed in a tapered shape such that the dimension between the two side edges 56b in the width direction F2 gradually increases from the proximal end 56a toward the distal end edge 56c. Alternatively, the positioning tab 56 may be formed such that a distal end portion of the positioning tab 56 is widened relative to the proximal end 56a so as to have a T-shaped configuration when viewed in the axial direction X, thereby making the dimension in the width direction F2 between the two side edges 56b larger than the dimension in the width direction F2 at the proximal end 56a.

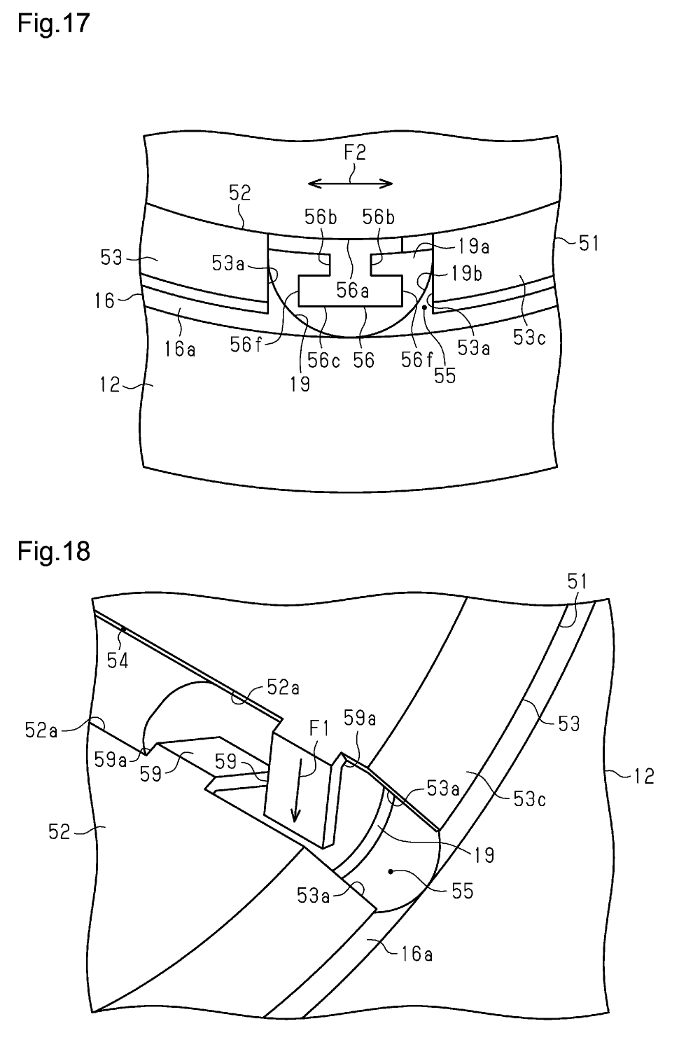

As shown in FIG. 17, the positioning tab 56 may have a stepped shape including two first side edges 56b extending in parallel to each other and two second side edges 56f extending in parallel to each other, in which the dimension in the width direction F2 between the two second side edges 56f is greater than the dimension in the width direction F2 between the two first side edges 56b.

In a state in which the positioning tab 56 is disposed inside the positioning recess 19, the two second side edges 56f face the arcuate inner surface 19b. The two second side edges 56f are located closer to the inner surface 19b than the first side edges 56b are. Accordingly, when a force to move the interposed member 51 in the circumferential direction B of the motor fixing surface 15a acts on the interposed member 51, one of the two second side edges 56f is brought into contact with the inner surface 19b more quickly.

As shown in FIG. 18, a positioning tab 59 may protrude from each of the two second end edges 52a of the interposed main body 52 so as to extend toward a portion of the inner surface 19b of the positioning recess 19 that is located on the opposite side of the second imaginary line M2 of the positioning recess 19. In this case, the positioning tabs 59 are located inside the second slit 54 when viewed in the radial direction of the housing 11. The proximal end 59a of each positioning tab 59 is located at the second end edge 52a of the interposed main body 52. The two positioning tabs 59 are formed at positions shifted from each other in the width direction of the interposed main body 52.

The positioning recess 19 extends from the tapered portion 16 to a position closer to the step 15b in the axial direction X of the first housing forming portion 12 than in the second embodiment.

According to this, each of the two positioning tabs 59 is arranged in the positioning recess 19 by extending from a portion positioned inside the second slit 54. In this case, each positioning tab 59 is likely to be caught by the inner surface 19b of the positioning recess 19. Accordingly, movement of the interposed member 51 in the circumferential direction B of the motor fixing surface 15a is readily suppressed by the two positioning tabs 59. This improves the positioning accuracy of the interposed member 51 in the circumferential direction B.

In the second embodiment, when the interposed member 51 including the two positioning tabs 58 is used, the first imaginary line M1 located between the two positioning tabs 58 and the reference line N of the positioning member 41 may be slightly shifted in the circumferential direction B of the motor fixing surface 15a.

In the first embodiment, the first imaginary line M1 of the positioning tab 56 and the second imaginary line M2 of the positioning recess 19 may be slightly shifted from each other in the circumferential direction B of the motor fixing surface 15a.

In the first embodiment, the distal end edge 56c of the positioning tab 56 may extend linearly in the width direction F2, or may be formed arcuately so as to be recessed toward the proximal end 56a. In this manner, the shape of the distal end edge 56c of the positioning tab 56 can be changed.

The positioning tab 56 that can be positioned by using the jig 70 as shown in FIG. 15 may include a through-hole extending in the thickness direction through the center of the positioning tab 56. In this case, the jig 70 is provided with an insertion protrusion to be inserted into the through-hole of the positioning tab 56 at the distal end portion of the projecting portion 74. The positioning tab 56 may be positioned while suppressing movement of the positioning tab 56 by bringing the insertion protrusion into contact with the inner peripheral edge forming the through-hole in the positioning tab 56.

The positioning tab 56 of the first embodiment may have an arcuate shape along the inner surface 19b of the positioning recess 19 when viewed in the axial direction X. In this case, the positioning tab 56 does not include the two side edges 56b, and edge portions extending from the opposite ends of the proximal end 56a extend arcuately along the inner surface 19b.

As long as the protrusions 43 that correspond to the second slit 54 are not entirely located inside the second slit 54, a part of each protrusion 43 may overlap the second slit 54. In other words, part of each protrusion 43 may extend into the second slit 54 as long as the force of the protrusion 43 pressing the interposed main body 52 toward the motor fixing portion 15 is not reduced.

In the first embodiment, of the two side edges 56b of the positioning tab 56, the side edge 56b continuous with the second end edge 52a may be located at the boundary between the positioning recess 19 and the motor fixing surface 15a, that is, at one end of the positioning recess 19 in the circumferential direction B of the motor fixing surface 15a. In other words, the second slit 54 may be out of the range of the positioning recess 19 in the circumferential direction B of the motor fixing surface 15a. That is, the second slit 54 may be displaced from the positioning recess 19 in the radial direction of the motor fixing portion 15 when viewed in the axial direction X.

The first housing forming portion 12 does not necessarily need to include the tapered portion 16, and may include an increasing diameter portion extending radially outward with respect to the motor fixing portion 15, and a cylindrical enlarged portion 17 extending in the axial direction X continuously with the increasing diameter portion. In this case, the interposed member 51 does not necessarily need to include the guide portion 53. In this case, the inner surface 19b of the positioning recess 19 is an arcuate surface that is recessed radially outward of the first housing forming portion 12 with respect to the motor fixing surface 15a.

The inner surface 19b of the positioning recess 19 may be a surface recessed in a rectangular shape toward a radially outer side of the first housing forming portion 12 when viewed in the axial direction X. As long as the positioning tab 56 can be disposed inside the positioning recess 19, the shape of the inner surface 19b of the positioning recess 19 and the shape of the positioning tab 56 viewed in the axial direction X can be modified.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A motor-driven compressor, comprising:
a motor;
a housing;
a positioning member made of metal; and
an interposed member made of metal, wherein
the motor includes a stator and is configured to drive a compression unit,
the housing includes:
a tubular first housing forming portion that accommodates the motor; and
a second housing forming portion connected to an open end of the first housing forming portion,
the first housing forming portion includes a motor fixing surface that surrounds the stator,
the positioning member includes:
a main body that extends in a circumferential direction of the motor fixing surface and covers an outer circumferential surface of the stator; and
multiple protrusions protruding from the main body toward the motor fixing surface,
the main body includes:
two first end edges facing each other in the circumferential direction; and
a first slit formed between the two first edges,
the interposed member includes an interposed main body interposed between the first housing forming portion and the positioning member and extending in the circumferential direction,
the interposed main body includes:
two second end edges facing each other in the circumferential direction; and
a second slit formed between the two second end edges,
a positioning recess is formed in an inner peripheral portion of the first housing forming portion by recessing, in an axial direction of the first housing forming portion toward an end opposite to the open end, a partial region, in the circumferential direction, of the inner peripheral portion, and
the interposed member includes a positioning tab that extends from at least one of the second end edges and is disposed inside the positioning recess.

2. The motor-driven compressor according to claim 1, wherein the positioning tab is one of two positioning tabs each extending from one of the second end edges.

3. The motor-driven compressor according to claim 2, wherein the positioning tabs are located inside the second slit when viewed in a radial direction of the housing.

4. The motor-driven compressor according to claim 1, wherein
when viewed in an axial direction of the housing, the positioning recess includes an arcuate inner surface that is open on the motor fixing surface, the inner surface being recessed toward a radially outer side of the first housing forming portion with respect to the motor fixing surface,
the positioning tab includes a proximal end located at a boundary with the interposed main body and a distal end located on an opposite side from the proximal end, the positioning tab extending in an extending direction from the proximal end to the distal end,
the positioning tab includes a distal end edge including the distal end and two side edges connecting the proximal end and the distal end edge to each other, the positioning tab extending from the proximal end toward the radially outer side of the first housing forming portion,
a direction in which a straight line along a front surface of the positioning tab and orthogonal to the extending direction extends is a width direction of the positioning tab, and
a dimension in the width direction between the two side edges is greater than or equal to a dimension in the width direction of the proximal end.

5. The motor-driven compressor according to claim 1, wherein the positioning tab includes a proximal end region including a proximal end located at a boundary with the interposed main body, and a protruding section protruding from a center of the proximal end region.

6. The motor-driven compressor according to claim 1, wherein
the positioning tab includes a proximal end located at a boundary with the interposed main body and a distal end located on an opposite side from the proximal end, the positioning tab extending in an extending direction from the proximal end to the distal end, and
the extending direction is parallel to a thickness direction of the second end edge.

7. The motor-driven compressor according to claim 1, wherein the positioning member and the interposed member are arranged such that the first slit and the second slit overlap each other when viewed in a radial direction of the housing.

8. The motor-driven compressor according to claim 1, wherein
the positioning tab includes a proximal end located at a boundary with the interposed main body and a distal end located on an opposite side from the proximal end, the positioning tab extending in an extending direction from the proximal end to the distal end, and
a first imaginary line extending through a center of the positioning tab in the circumferential direction and extending in the extending direction coincides with a second imaginary line extending through a center of the positioning recess in the circumferential direction and extending in the extending direction.
